(19) United States
(12) Patent Application Publication
(10) Pub. No.: US 2006/0041855 A1
(43) Pub. Date: Feb. 23, 2006

(54) Methods and systems for web-based software design

(76) Inventors: Timothy P. Torgerson, Wauwatosa, WI (US); Bryan Strassner, Union, MO (US); Dean Petterson, San Ramon, CA (US); Chris Greer, Granite City, IL (US); Keith Lofy, Menomonee Falls, WI (US); Guy Caldwell Hoffman, 88 Amigo Lane, CA (US); Andrew Benjamin Robinson, 6318 Mount Olympus Drive, CA (US); Stanley McWhorter Weir, 8063 Crossridge Road, CA (US); Milton Robert Yoder, 10747 Roxanna Drive, MO (US)

Correspondence Address: HARNESS, DICKEY & PIERCE, P.L.C., P.O. BOX 8910, RESTON, VA, 20195, US

(21) Appl. No.: 10/920,170

(22) Filed: Aug. 18, 2004

(51) Int. Cl. G06F 9/44

(52) U.S. Cl. 717/101

(57) ABSTRACT

The design of software is facilitated using a web-based graphical user interface (GUI). The web-based GUI can select information from a number of diverse databases.

A portion of the disclosure of this patent document contains material that is subject to copyright protection. The copyright owner has no objection to the facsimile reproduction by anyone of the patent document or patent disclosure as it appears in the United States Patent and Trademark Office patent file or records, but otherwise reserves all copyright rights whatsoever.

### BACKGROUND OF THE INVENTION

Many enterprises (e.g., telecommunication service providers) are eventually faced with the prospect of designing new, or modifying existing, software applications and systems. Most use word processing packages to store information concerning past software designs, modifications, etc. When stored in this manner, however, the information cannot be easily accessed for future use or queried. It is, therefore, desirable to provide a better means for accessing and querying information to enable the creation of new software designs and modifications. It also is desirable to reuse previous designs in order to conserve resources that otherwise would be spent in reinventing and documenting new designs.

### SUMMARY OF THE INVENTION

We have recognized that information relating to software designs stored in a number of diverse databases may be accessed, queried and selected using a web-based graphical user interface (GUI). In accordance with one method, either a project work order from a first database or a software defect notice from a second database can be selected, using the GUI, and used as a so-called “work effort.” Thereafter, the GUI may also enable the selection of one or more software components associated with a particular design scenario which may be used to complete the work effort.

The ability to access, query and select information from one or more databases using a web-based GUI to create or edit software applications and the like provides telecommunications service providers and similar enterprises with a capability not previously available prior to the present invention.

### BRIEF DESCRIPTION OF THE DRAWINGS

FIG. 1 is a block diagram of a system for facilitating the design of software in accordance with one embodiment of the present invention;

FIGS. 2A and 2B are flow diagrams of a method for facilitating the design of software in accordance with an embodiment of the present invention; and

FIGS. 3-11 are illustrations of screens generated and displayed by a GUI in accordance with embodiments of the present invention.

### DETAILED DESCRIPTION OF THE INVENTION

Generally, the present invention provides a system analyst or the like with the ability to access, query and select information, such as detailed business and technical requirements, stored in a number of diverse databases. Once accessed, queried or selected, the information may be used to formulate a detailed design for creating or modifying a software application.

The present invention enables an analyst to define a degree of complexity for new and/or modified software components. As this process is proceeding, the present invention may also generate estimates specifying the amount of time needed to develop and deploy the necessary software components.

As used herein, the term “work effort” is used to refer to a business and/or technical requirement that is to be completed by specifying, designing and developing one or more software components. The term “design scenario” is used herein to refer to a plan for completing a work effort. As further described below, an analyst may formulate more than one design scenario for completing a given work effort. The analyst may also associate the same and/or different software components with different scenarios. In addition, various scenarios can be compared with one another in the course of determining a detailed design (“DD”) for completing the given work effort.

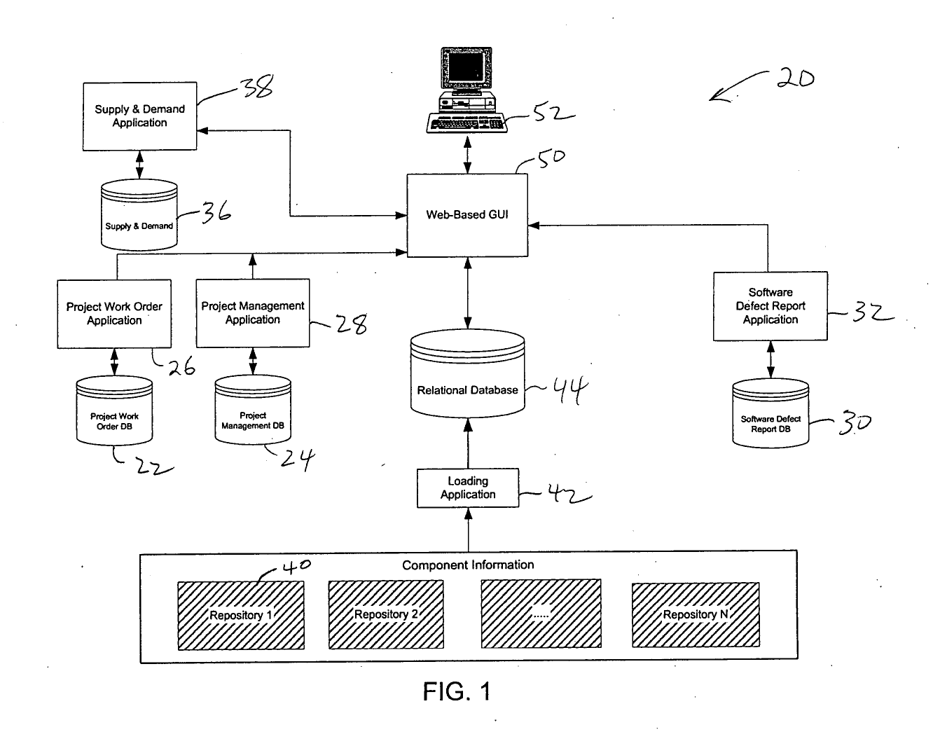

Referring now to FIG. 1, there is shown one configuration of a GUI-based system for facilitating the design of software. By “facilitating” is meant at least giving an analyst or the like: (a) access to software design components, and their associated specifications, etc.; (b) the ability to select certain components, etc., and generate time estimates; and (c) the ability to query all of the above. The system 20 may be used, for example, in an enterprise to support the creation and storage of designs for maintaining and upgrading software applications. Though the discussion which follows uses telecommunications service-related software as an example of the type of software which can be accessed, queried and/or selected, other similar software may also be so treated.

As shown in FIG. 1, the system 20 includes: a project work order database 22 that stores information pertaining to past, present and/or future work requests, projects and/or plans of the enterprise, etc.; a project management database 24 that stores information pertaining to the scheduling of work requests, projects and/or plans; a project work order application 26 that provides a plurality of project work orders which may be eligible for release commitments by the enterprise; and a project management application 28 that provides project management information to supplement information provided by the project work order application 26. The term “release commitment” describes a commitment of time and funding by the enterprise for the development of software to be included in a software release.

Specifically, the application 28 may provide information to the system 20 pertaining to whether or not work is going to proceed on a particular project and in what release (if any) a project is to be included.

The project work order application 26 may include, for example, a project management application provided by Artemis International Solutions Corp. of Newport Beach, Calif. and/or web-based document software such as eVista, by OptiScan, Inc. of Phoenix, Ariz. The project management application 28 may be a project management tool such as Microsoft® Project.

System 20 also includes a software defect database 30 that stores information pertaining to software trouble reports and the processing of such reports. The database 30 may be maintained using software provided, for example, by The Vantive Corporation of Mountain View, Calif. A software defect report application 32 may provide the system 20 with a plurality of software defect notices. As further described below, a user may select a work effort from among the software defect notices and/or project work orders provided to the system 20 from the software defect database 30 and/or the project work order database 22. Such a user may be, for example, an analyst who wishes to initiate and/or contribute to a software specification for completing a work effort.

Also shown in FIG. 1 is a supply-and-demand database 36 that stores timesheet data and other information pertaining to time expended by, and/or potentially expendable by, software developers working for the enterprise. A supply-and-demand application 38 provides time-related information available to the system 20 for use in generating time estimates in connection with work efforts.

A plurality of software components may reside in one or more repositories 40. The components may be of various types including, but not limited to, software configuration management components, enterprise change management software components, input/output files, reports, screens, objects, tools and/or tables.

A loading application 42 may provide software component addresses and/or other information pertaining to software components stored in the repositories 40 to a relational database 44. The database 44 may be structured and maintained, for example, using software by Oracle Corporation of Redwood Shores, Calif.

In one embodiment for the present invention, a web-based, GUI 50 interfaces with the supply-and-demand application 38 and the relational database 44. A user of a client terminal 52 (who may be, e.g., a software specification designer) may access and select: a work effort from the project work order application 26; and/or software defect reports provided by the software defect report application 32 via the GUI 50. The user may use the GUI 50 to create a design scenario for completing the selected work effort. The user may also use the GUI 50 to access, query, select and store one or more specifications for one or more software components in the relational database 44 and link the software component specification(s) with the design scenario. This allows the user of the terminal 52 (and/or another user of another client terminal, for example, an application analyst) to use the GUI 50 to access the linked specification(s) in the relational database 44 via the design scenario at a later time.

Before going further, it should be understood that each of the components of FIG. 1 may store other types of information other than the type described above; the above merely represent examples of such information. It should be further understood that each of the components in FIG. 1 may comprise one or more computer readable mediums (e.g., storage devices), processors (e.g., microprocessors) or a combination of the two to store and/or execute one or more programs to carry out the features and functions of the present invention.

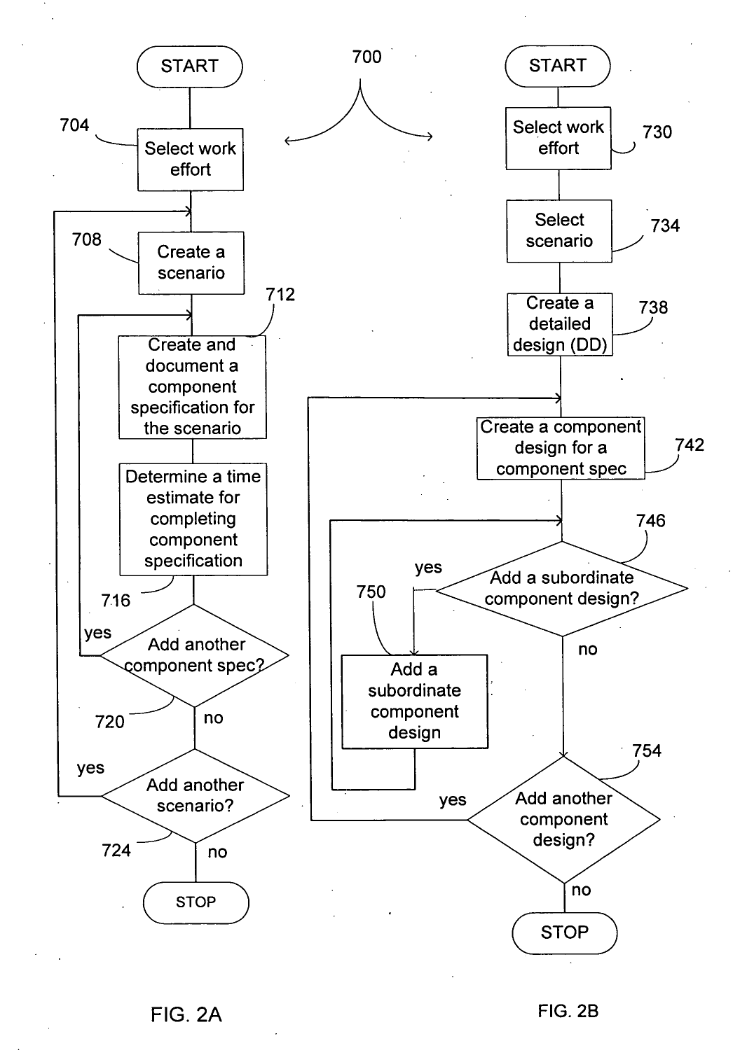

A flow diagram of one implementation of a method for facilitating the design of software is indicated generally in FIGS. 2A and 2B by reference number 700. Steps of the method 700 will be described in general terms with reference to FIGS. 2A and 2B and, in further detail, with reference to various screens that may be displayed by the GUI 50. It should be noted that the steps in FIGS. 2A and 2B are only examples of how the GUI 50 may be used in connection with the system 20; in sum, the GUI 50 may be used in a plurality of ways to perform a plurality of functions.

A user (the “first user”) wishing to create new software specifications for a particular work effort may use the GUI 50 to perform the steps shown in FIG. 2A. At step 704 the first user selects the work effort, e.g., a project work order or a software defect as described above. At step 708 the first user creates a scenario for completing the work effort. At step 712 the first user then selects and documents a software component specification for the scenario. To “document” a component specification means, for example, to add or update information describing the specification, as further described below. Next, at step 716 the first user determines a time estimate for completing the component specification and associates the estimate to the specification. If at step 720 it is determined that another component specification is to be added, control returns to step 712. If the first user has finished adding component specifications, control passes to step 724. If at step 724 the first user specifies that another scenario is to be added, control returns to step 708.

After the foregoing steps are completed, one or more scenarios are associated with the work effort in the system 20, and one or more software component specifications are associated with a scenario. A second user (who could be the first user) may then create a more detailed design for the scenario(s), for example, as described with reference to steps shown in FIG. 2B.

At step 730 the second user selects the same work effort as previously selected at step 704. At step 734 the second user selects one of the scenario(s) previously created at step 708. At step 738 the second user creates a DD (detailed design) corresponding to the selected scenario. The newly created DD may eventually be built upon to include detailed software designs for the components specified. Thus, for example, at step 742, the second user, having referred to a given component specification previously created and documented at step 712, creates a component design for the given component specification.

At step 746 it is determined whether to include a design for another software component subordinate to the given component, Le., another component that is to be designed in the course of designing the given component. A subordinate component may be, for example, a software object that will be invoked by the given component. If the decision is yes, then at step 750 the second user creates a subordinate component design and associates it with the component design created at step 742. Thus, by adding component designs and in some cases subordinate component designs, the second user builds a DD associated with the selected scenario. If at step 746 it is determined that a subordinate component design is not to be added to the component design, control passes to step 754.

If at step 754 it is determined that another component design is to be added to the DD, control returns to step 742. In the foregoing manner, the second user can use the specifications created by the first user to create detailed designs for completing the work effort.

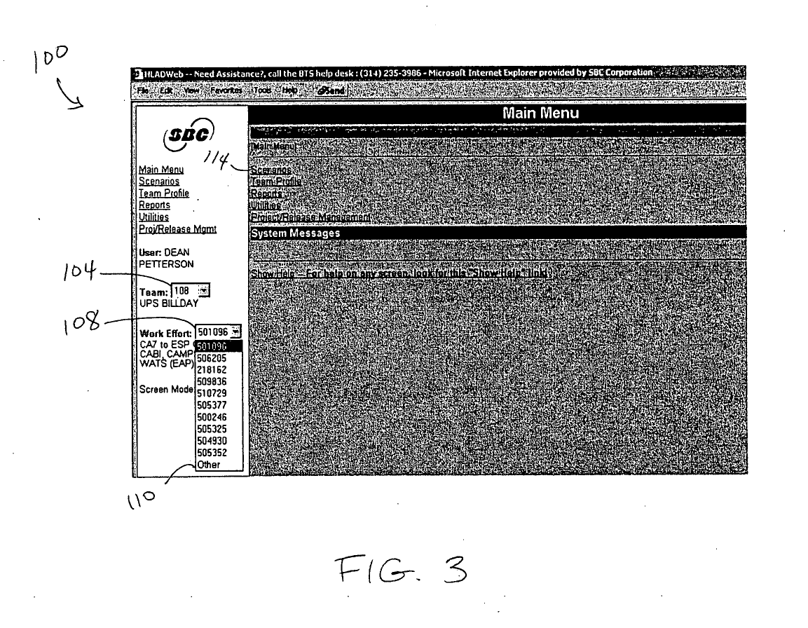

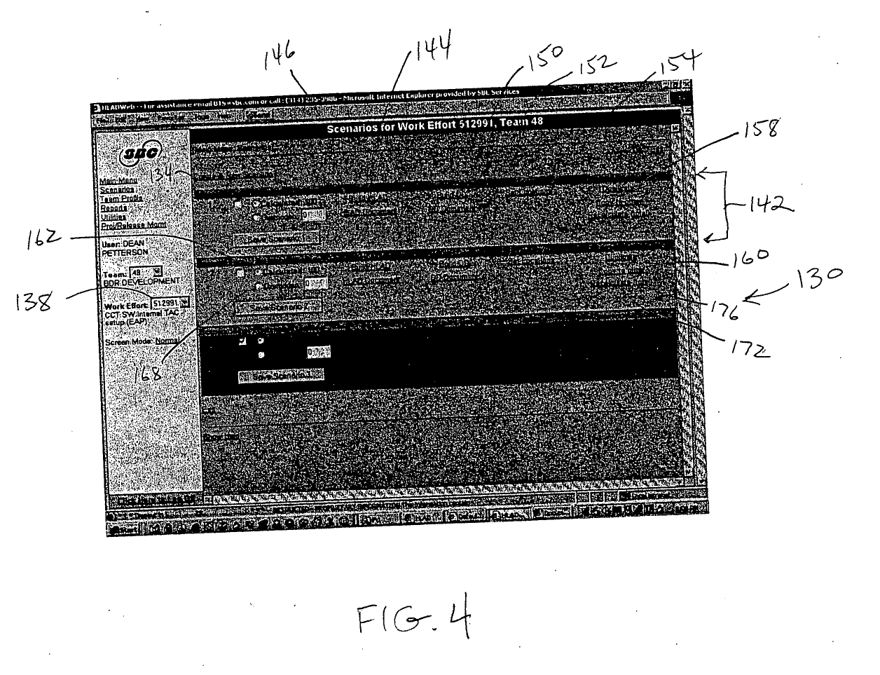

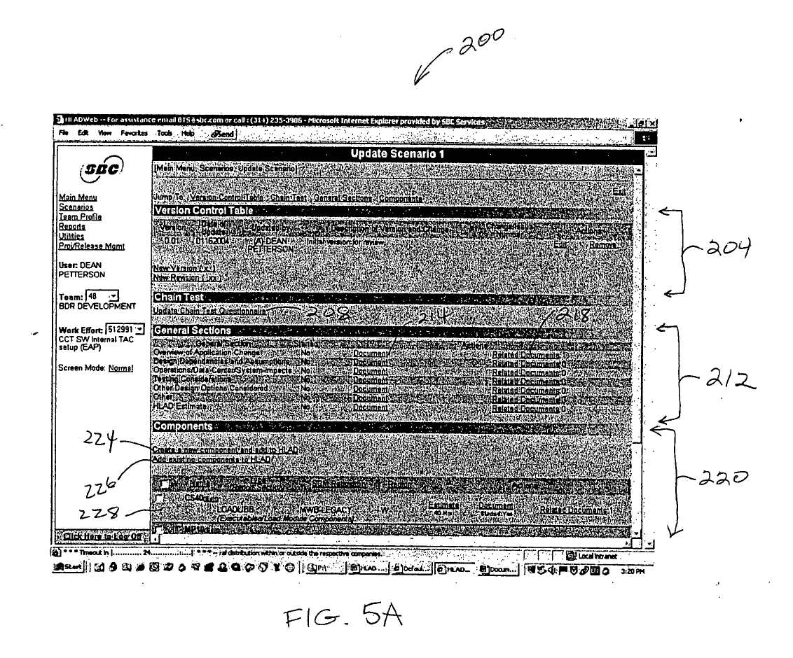

Various screens that may be displayed by the GUI 50 during operation of the system 20 of the present invention shall now be described. Generally, various web-based links allow a user to navigate through and use various features of the system 20. A user may select a work effort from a “Main Menu” screen indicated generally in FIG. 3 by reference number 100. The user may use a drop-down menu 104 to select a desired development team and a drop-down menu 108 to select a work effort from recently used work efforts. By selecting an “Other” category 110 the user may activate a screen (not shown) from which a work effort not listed in the menu 108 may be selected from the project work orders and/or software defect reports.

After selecting a team and a work effort, the user may proceed to create and/or manage one or more design scenarios for completing the selected work effort. For example, by activating a “Scenarios” link 114 the user may cause to be displayed a “Scenarios for Work Effort and Team” screen indicated generally in FIG. 4 by reference number 130. The user may activate the screen 130 to perform a plurality of functions. For example, by activating a link 134 the user may create a new scenario for a selected work effort 138. Generally, a design scenario may be structured to include one or more specifications for one or more software components that may reside (currently or eventually) in one or more repositories 40. By creating more than one scenario for completing a work effort, a designer can specify designs for software components in more than one way and can compare potential impacts of such designs.

The screen 130 includes three scenario function areas 142. By activating a “Build HLAD” link 144, the user may select, remove, estimate, document and/or edit component specifications associated with the selected scenario. By activating a “HLAD Document” link 146 the user may cause a document to be formatted (for print and/or display on the terminal 52) that describes the selected scenario. As used herein, a “HLAD” (“high-level application design”) refers to a scenario for completing a work effort and one or more component specifications associated with the scenario. In one configuration, a HLAD identifies and describes, for a given application development team, new components and/or modifications to be made to existing components. A HLAD may capture application and/or system design specifications at a relatively general level which subsequently may be used, for example, by an application analyst to create a DD for the specified components.

Referring again to FIG. 4, a user who wishes to generate a DD relative to an existing HLAD may activate a “Build DD” link 150 to configure a DD, e.g., to select, remove, document and/or edit component specifications associated with the selected scenario to obtain detailed designs for the specified components. A DD typically includes component design specifications which are more detailed than specifications included in the associated scenario HLAD. For example, a design specification for a given component in a DD may include one or more specifications for one or more subordinate components of the given component. By activating a “DD Document” link 152 the user may cause a document to be formatted (for print and/or display on the terminal 52) that describes the DD associated with the selected scenario.

A number of features useful for managing work effort specifications at a scenario level are available on the screen 130. For example, the system 20 may be used in an enterprise having regional data centers and/or databases (referred to herein as “locations”) in various geographical regions of enterprise operation. New and/or redesigned software components may need to be delivered, e.g., downloaded, to one, several or all of the locations when a work effort is completed. Accordingly, activating a “Set Locations” link 154 causes a screen (not shown) to be displayed that allows the user to assign specific delivery locations to software components included in the selected scenario.

A “Duplicate” activator 158 allows the user to cause the selected scenario to be duplicated. The system 20 assigns a new scenario number to the duplicate scenario. The duplicate scenario can be modified by the user, for example, to provide an alternative HLAD. A “Copy to other” link 160 allows the user to make a copy of the selected scenario and associate the copy with another work effort and/or another team.

Certain indicators within the screen 130 shown in FIG. 4 allow a user to modify estimates. For example, a “Calculated” indicator 162 indicates whether a time estimate has been calculated for the scenario as further described below. The indicator 162 also indicates an amount of such estimate if one is in effect. An “Overridden” indicator 168 indicates whether a calculated time estimate is overridden and allows the user to enter an override amount. A “Recalculate” activator 172 re-calculates a time estimate while keeping any component estimate override that may have been made. A “(total)” activator 176 causes recalculation of time estimate(s) for each component specification associated with the scenario. A user may wish to use the activator 176 if base hours for a component type have been changed.

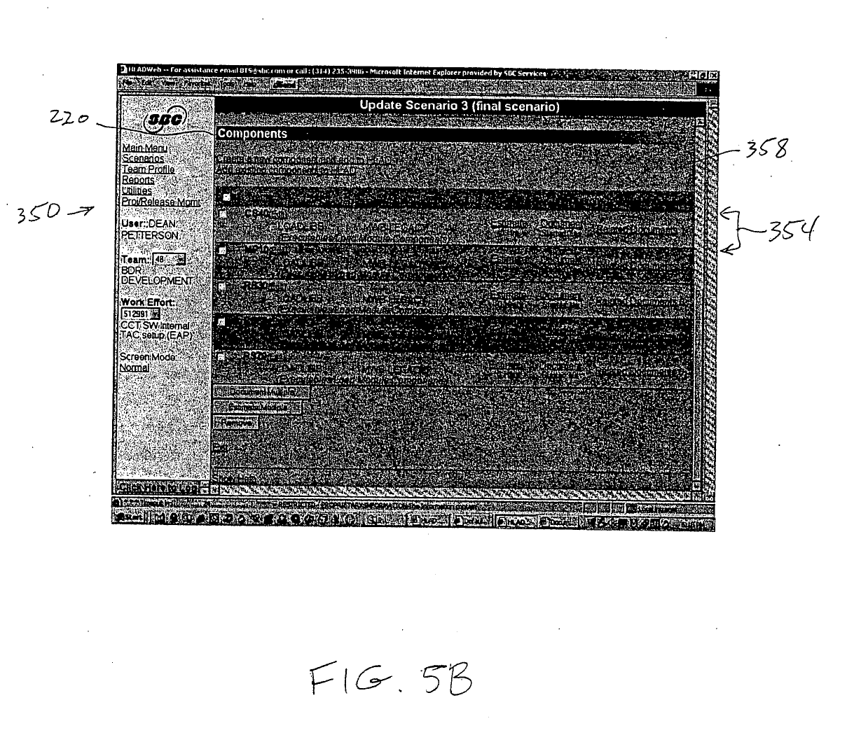

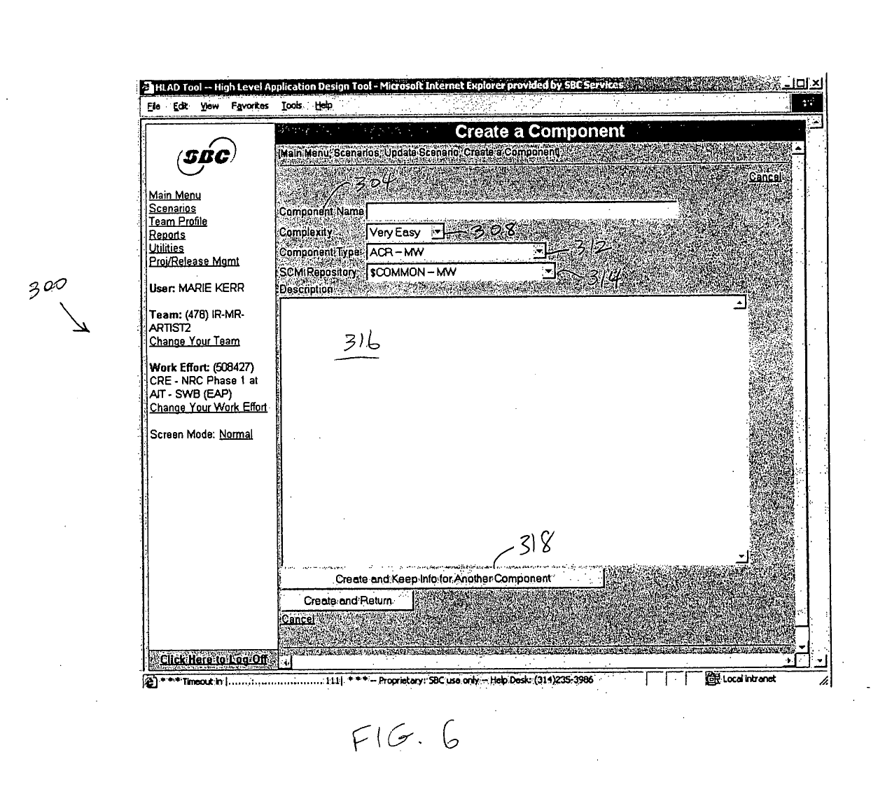

When the “Build HLAD” link 144 is activated, an “Update Scenario” screen may be displayed as indicated generally by reference number 200 in FIG. 5A. Generally, the screen 200 may be used to update a selected scenario and/or to add and/or modify component specifications. A version control table 204 allows a user to maintain various versions of the selected scenario. A link 208 allows the user to update a chain test questionnaire (not shown). The questionnaire can be designed to determine whether chain testing of modified software components included in the scenario may be required or recommended. (In other configurations, additional types of testing could be addressed with reference to a scenario.)

A General Sections area 212 allows the user to enter general information pertaining to a selected scenario. By activating a “Document” link 214, the user causes a screen (not shown) to be displayed whereby the user may enter information pertaining to a corresponding general section of the selected scenario. General sections typically include descriptive text and may describe, for example, an overview of an application change, design dependencies and assumptions, operation/data center/system impacts, testing considerations, other design options considered, and an HLAD estimate. By activating a “Related Documents” link 218, the user causes a screen (not shown) to be displayed whereby the user may enter information to create a link to a related document in the system 20. In this manner a user can associate one or more documents stored in the system 20 with a general section.

A Components section 220 includes a “Create a new component” link 224 that allows the user to create a new component specification and add it to the HLAD. An “Add existing components” link 226 allows the user to add an existing component specification to the HLAD. Component specifications 228 included in the scenario are listed in the Components section 220. Components may be listed by name, type, repository, and/or location where maintained. Status of actions with respect to a component may include whether a time estimate has been made and/or an amount of such estimate, whether documentation has been entered, and whether links to any related documents have been added.

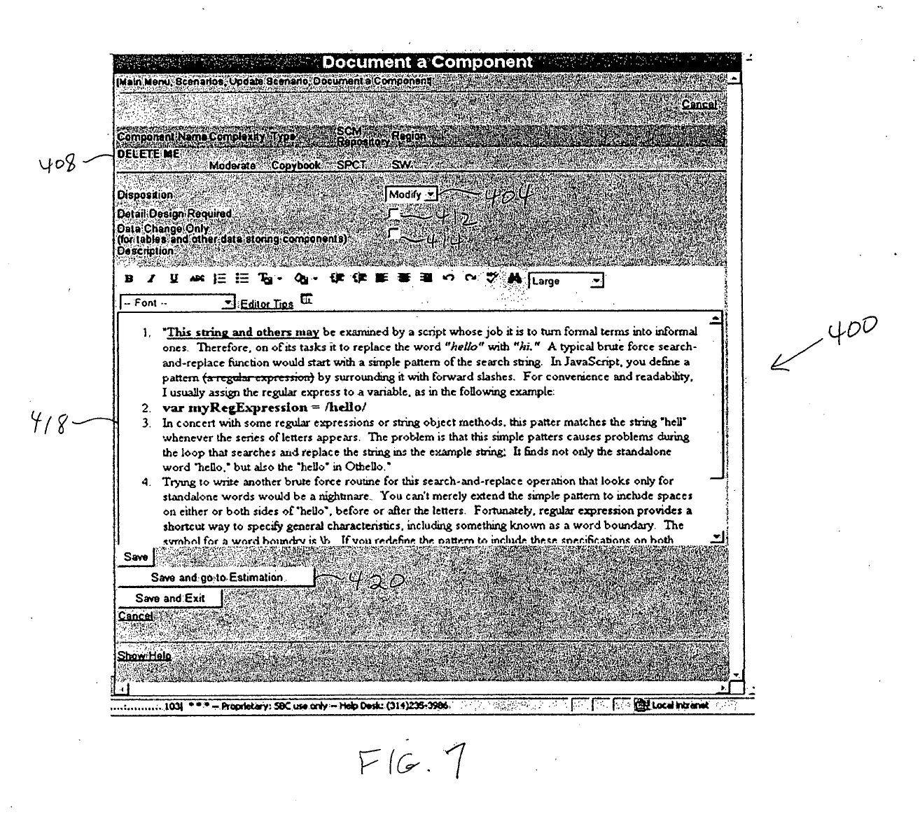

When the “Create a new component” link 224 (shown in FIG. 5A) is activated, a “Create a Component” screen 300 may be displayed as shown in FIG. 6. The user may enter a component name 304, complexity 308, component type 312, name 314 of a repository 40, and description 316. A “Create and keep info for another component” activator 318, for example, allows the user to save a current component and add another component to the selected scenario or to another scenario that includes some of the previously entered information.

When components have been added to a scenario, a screen 350 may be displayed as shown in FIG. 5B. The screen 350 is an “Update Scenario” screen similar to the screen 200 shown in FIG. 5A and is scrolled further down than the screen 200 to display various components. The Components section 220 (previously described with reference to FIG. 5A) includes five component specifications 354. The user may activate a “Document” link 358 associated with a component specification 354 to enter information relating to a particular component.

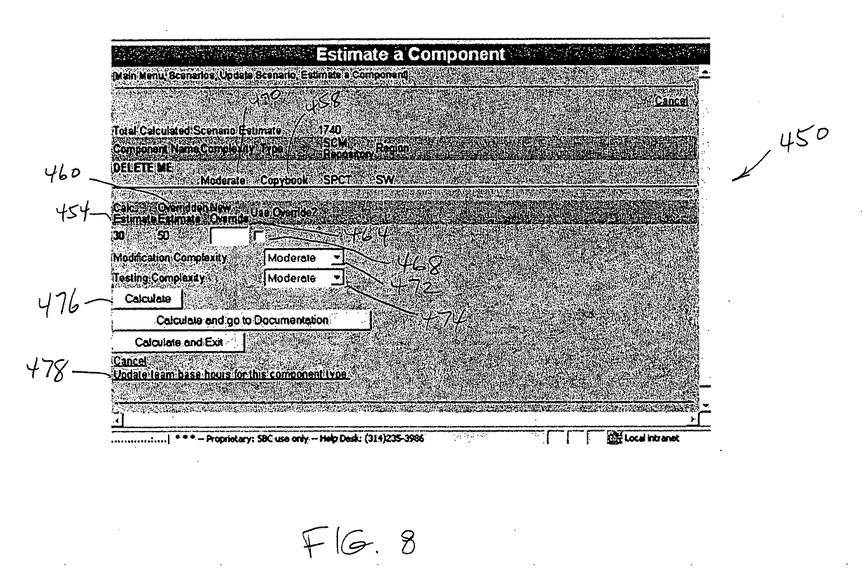

When a “Document” link 358 is activated, a “Document a Component” screen 400 may be caused to be displayed as shown in FIG. 7. The user may select from a component disposition drop-down menu 404 to indicate whether a component named in an area 408 is being added, modified or deleted with respect to the selected scenario. By checking one of boxes 412 and 414, the user may indicate whether a detailed design is required or whether a data change only is being made. A component specification description may be included in an area 418.

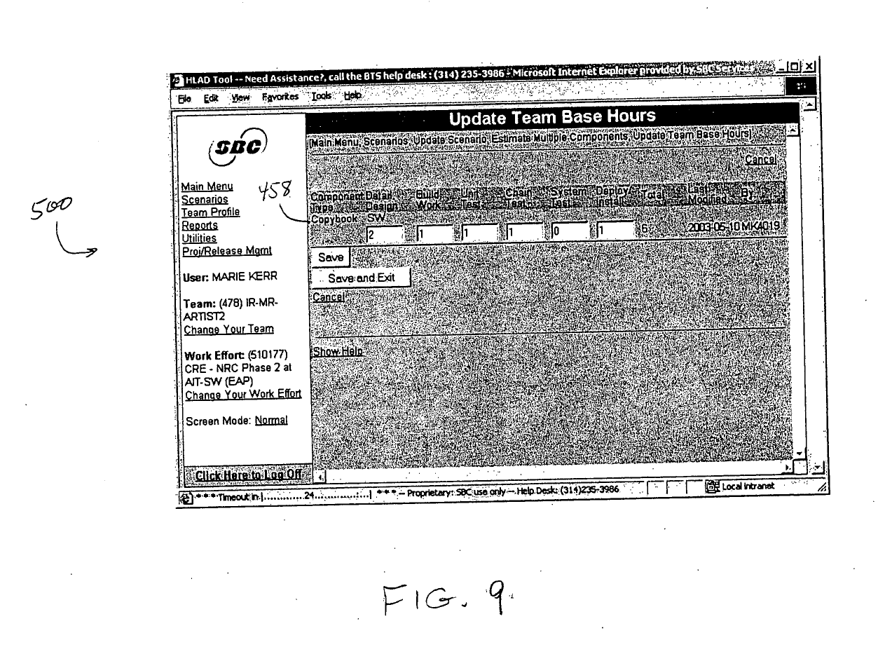

When the user activates an activator 420, the component information is saved, e.g., in the database 44 (see FIG. 1), and the GUI may display a screen 450 as shown in FIG. 8. Using the screen 450, the user may estimate a time for meeting the selected component specification. In the present configuration, an estimate is determined by summing a plurality of base hours multiplied by complexity factors as further described below. A “Calc Estimate” area 454 displays a calculated estimate based on complexities and base hours for a component type 458. An “Overridden Estimate” area 460 indicates an estimate that has been overridden by the user. The user may enter an estimate that overrides the overridden estimate when an estimate is calculated in a “New Override” field 464. A “Use Override?” checkbox 468 may be used to indicate whether the override or calculated estimate is to be used.

A “Component Complexity” area 470 indicates a complexity assigned to the component and which is not alterable from the screen 450. A “Modification Complexity” box 472 allows the user to select a degree of difficulty of changes for the selected component. A “Testing Complexity” box 474 allows the user to select a degree of difficulty of testing for the selected component. A “Calculate” button 476 may be activated to save an estimate, e.g., in the relational database 44. An “Update team base hours for this component type” link 478 allows the user to change base hours assigned for the selected component type.

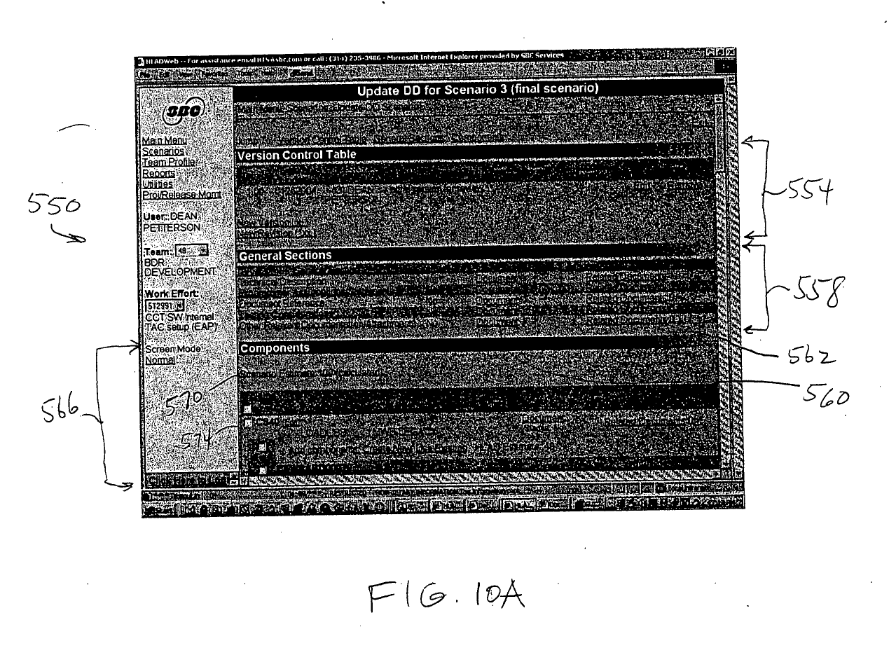

When the link 478 is activated, an “Update Team Base Hours” screen 500 may be displayed as shown in FIG. 9. A user may change an hours estimate for any of a plurality of stages of software development for the specified component type 458. For example, as shown in FIG. 9, a copybook component type 458 is estimated as requiring two hours of detail design, one hour of build work, one hour of unit test, one hour of chain test, no hours of system test, and one hour of deploy/install time.

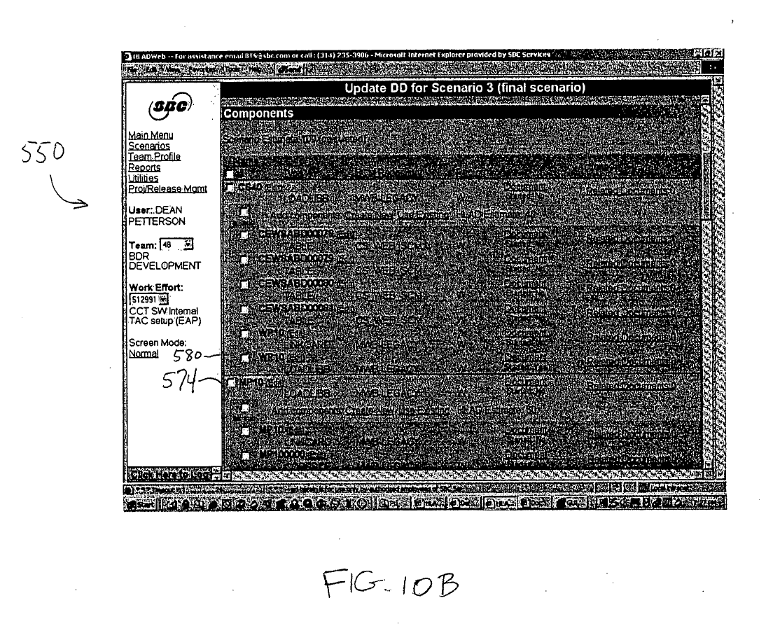

By activating the “Build DD” link 150 (shown in FIG. 4), the user may cause an “Update DD for Scenario” screen 550 to be displayed as shown in Figures 10A and 10B. The screen 550 allows the user to perform functions relative to a DD associated with the selected scenario, as previously discussed with reference to FIG. 4. A version control table 554 allows the user to maintain various versions of the DD. A General Sections area 558 allows the user to enter general information pertaining to the selected DD. By activating a “Document” link 560, the user causes a screen (not shown) to be displayed whereby the user may enter information pertaining to a corresponding general section. General sections may describe, for example, a technical description, programmer assumptions and/or statements, document reference, testing considerations, and other relevant documentation/attachments. It should be noted that General Sections 558 may be, but do not have to be, the same General Sections included in the area 212 (shown in FIG. 5A) pertaining to the selected scenario. The General Sections 558 thus may describe elements that may be more relevant to the detailed design than to specifications set forth in the scenario.

By activating a “Related Documents” link 562, the user causes a screen (not shown) to be displayed whereby the user may enter information to create a link to a related document in the system 20. A Components section 566 includes a time estimate 570 in hours to complete the selected scenario. Component designs 574 are also included and are more clearly shown in Figure 10B.

A user may derive component designs 574 from component specifications 228 included in the HLAD scenario associated with the selected DD, as previously discussed with reference to FIGS. 4, 5A and 5B. An analyst, for example, who uses a HLAD as an aid in formulating a DD for a scenario and/or component of the scenario may determine that other or additional components may be impacted by the DD. Accordingly, the DD may include one or more subordinate component designs 580 associated with one or more of the component designs 574.

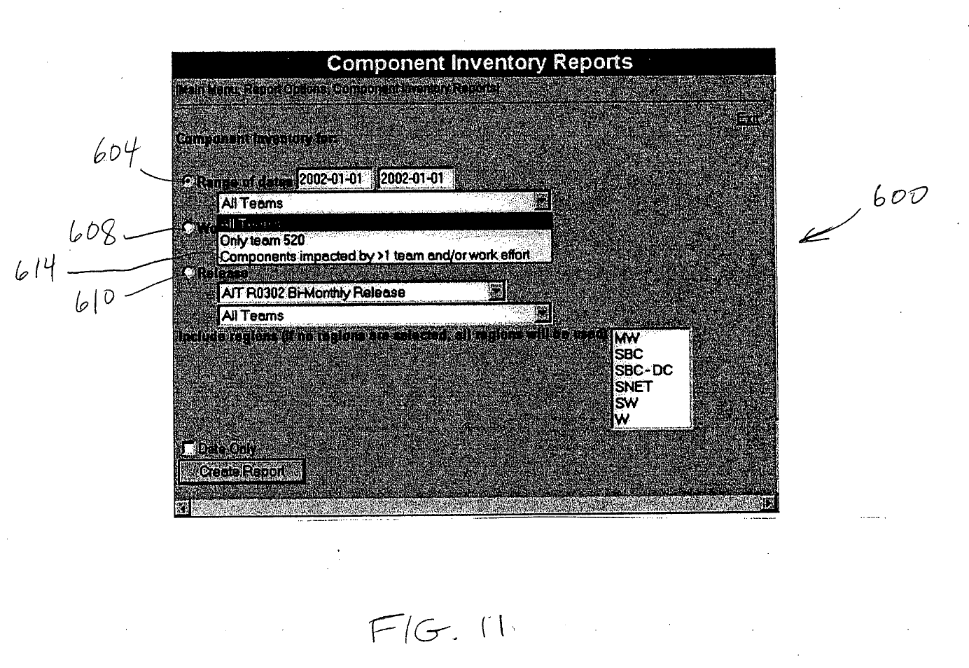

A user can query the system 20 to obtain information pertaining to work efforts, scenarios, DDs, development teams, software components and other aspects and elements of the system 20. For example, the system 20 can be queried via a “Component Inventory Reports” screen 600 as shown in FIG. 11 to provide an inventory report of software components. A report may be selected, for example, with reference to a range of dates 604, a work effort and/or team 608, and/or a release 610. When a menu item 614 is selected, it can be determined whether a software component is impacted by more than one team and/or work effort.

The foregoing system and methods make it possible to reuse previous designs and to create new designs based on previous designs. Thus, many hours of software design can be saved that otherwise would have been spent on reinventing and re-documenting designs that already had been created. The foregoing system provides a central repository for software component-level estimates and component inventories. Manual work previously needed to produce and access such information is greatly reduced. Software defect reports and project work orders are gathered, filtered and placed in relational database structures. The foregoing system can provide query support for various software applications to provide useful information within an enterprise. Additionally, the foregoing system provides an easily auditable and repeatable design process.

The above has set forth some examples of the present invention. The true scope of the present invention is better defined by the claims which follow.

1. A method for facilitating the design of software, the method comprising the steps of:
selecting at least one of a project work order from a first database or a software defect notice from a second database as a work effort; and
creating a design scenario for completing the selected work effort, said steps performed using a web-based graphical user interface (GUI).

2. The method of claim 1 further comprising the step of activating one or more links using the GUI to display the design scenario in one or more screens.

3. The method of claim 1 further comprising displaying the design scenario and one or more software component specifications associated with the scenario as a high-level application design (HLAD) using the GUI.

4. The method of claim 1 further comprising:
selecting a component specification associated with the design scenario; and
creating a component design for the component specification using the GUI.

5. The method of claim 1 further comprising:
selecting a software component specification for the scenario; and
associating a time estimate, for completing the specification, to the specification using the GUI.

6. The method of claim 5 wherein associating the time estimate to the software component specification comprises:
associating at least one of a modification complexity or a testing complexity with the specification; and
combining the associated complexity with at least one base hour value to obtain the time estimate using the GUI.

7. The method of claim 6 further comprising:
associating a development team with the software component specification; and
determining the at least one base hour value based on the associated team using the GUI.

8. The method of claim 5 further comprising optionally determining:
whether the software component is associated with more than one work effort;
whether the software component is associated with a particular development team; or
whether the software component is maintained in a particular location using the GUI.

9. The method of claim 1 further comprising:
associating a component design with the design scenario; and
associating a subordinate component design with the component design using the GUI.

10. The method as in claim 1 wherein the software comprises telecommunications service-related software.

11. A graphical user interface (GUI) for facilitating the design of software operable to:
select at least one of a project work order from a first database or a software defect notice from a second database as a work effort; and
create a design scenario for completing the selected work effort.

12. The GUI of claim 11 further operable to activate one or more links to display the design scenario in one or more screens.

13. The GUI of claim 11 further operable to display the design scenario and one or more software component specifications associated with the scenario as a high-level application design (HLAD).

14. The GUI of claim 11 further operable to:
select a component specification associated with the design scenario; and
create a component design for the component specification.

15. The GUI of claim 11 further operable to:
select a software component specification for the scenario; and
associate a time estimate, for completing the specification, to the specification.

16. The GUI of claim 15 further operable to:
associate at least one of a modification complexity or a testing complexity with the specification; and
combine the associated complexity with at least one base hour value to obtain the time estimate.

17. The GUI of claim 16 further operable to:
associate a development team with the software component specification; and
determine the at least one base hour value based on the associated team.

18. The GUI of claim 11 further operable to optionally determine:
whether the software component is associated with more than one work effort;
whether the software component is associated with a particular development team; or
whether the software component is maintained in a particular location.

19. The GUI of claim 11 further operable to:
associate a component design with the design scenario; and
associate a subordinate component design with the component design.

20. The GUI of claim 11 wherein the software comprises telecommunications service-related software.

21. A method for facilitating the design of telecommunication service-related software, the method comprising the steps of:
accessing a first specification for a software component using a first design scenario;
obtaining a second specification for the software component using the first specification; and
associating the second specification with a second design scenario;
said steps performed using a web-based graphical user interface (GUI).

22. The method of claim 21 further comprising selecting two different work efforts from at least one database to access the first and second design scenarios.

23. The method of claim 21 further comprising obtaining a time estimate for meeting the second specification using a time estimate for meeting the first specification.

24. The method of claim 21 further comprising displaying at least one of the first and second design scenarios in one or more screens using one or more web-based links.

25. A graphical user interface (GUI), for facilitating the design of telecommunication service-related software, operable to:
access a first specification for a software component using a first design scenario;
obtain a second specification for the software component using the first specification to; and
associate the second specification with a second design scenario.

26. The GUI of claim 25 further operable to select two different work efforts from at least one database to access the first and second design scenarios.

27. The GUI of claim 25 further operable to obtain a time estimate for meeting the second specification using a time estimate for meeting the first specification.

28. The GUI of claim 25 further operable to display at least one of the first and second design scenarios in one or more screens using one or more web-based links.

29. A computer readable medium operable to store one or more programs for:
selecting at least one of a project work order from a first database or a software defect notice from a second database as a work effort; and
creating a design scenario for completing the selected work effort.

30. The computer readable medium as in claim 29 further operable to store one or more programs for activating one or more links to display the design scenario in one or more screens.

31. The computer readable medium as in claim 29 further operable to store one or more programs for displaying the design scenario and one or more software component specifications associated with the scenario as a high-level application design (HLAD).

32. The computer readable medium as in claim 29 further operable to store one or more programs for:
selecting a component specification associated with the design scenario; and
creating a component design for the component specification.

33. The computer readable medium as in claim 29 further operable to store one or more programs for:
selecting a software component specification for the scenario; and
associating a time estimate, for completing the specification, to the specification.

34. The computer readable medium as in claim 29 further operable to store one or more programs for:
associating at least one of a modification complexity or a testing complexity with the specification; and
combining the associated complexity with at least one base hour value to obtain the time estimate.

35. The computer readable medium as in claim 34 further operable to store one or more programs for:
associating a development team with the software component specification; and
determining the at least one base hour value based on the associated team.

36. The computer readable medium as in claim 29 further operable to store one or more programs for determining:
whether the software component is associated with more than one work effort;
whether the software component is associated with a particular development team; or
whether the software component is maintained in a particular location.

37. The computer readable medium as in claim 29 further operable to store one or more programs for:
associating a component design with the design scenario; and
associating a subordinate component design with the component design.

38. The computer readable medium as in claim 29 wherein the one or more programs comprise telecommunications service-related programs.

39. A relational database operable to store at least software component information and time estimates associated with the information.

40. The database as in claim 39 wherein the information comprises software component specifications.

41. The database as in claim 39 wherein the information comprises web-based, graphical user interface originated information.
